(19) United States
(12) Patent Application Publication
(10) Pub. No.: US 2012/0076418 A1
(43) Pub. Date: Mar. 29, 2012

(54) FACE ATTRIBUTE ESTIMATING APPARATUS AND METHOD

(75) Inventors: Yukiyoshi SASAO, Kanagawa (JP); Mamoru Sakamoto, Kanagawa (JP)

(73) Assignee: RENESAS ELECTRONICS CORPORATION

(21) Appl. No.: 13/186,866

(22) Filed: Jul. 20, 2011

(30) Foreign Application Priority Data
Sep. 24, 2010 (JP) 2010-213825

(51) Int. Cl. G06K 9/46

(52) U.S. Cl. 382/195

(57) ABSTRACT

To provide a face attribute estimating apparatus capable of determining a face attribute with high precision. A scan region extracting part extracts, as a scan region, a region in which a specific face part can exist from a face region detected by a face detecting part. A region scanning part sets a small region in the scan region extracted by the scan region extracting part and, while scanning the scan region with the small region, sequentially outputs a pixel value in the small region. A pattern similarity calculating part sequentially calculates similarity between the pixel value output from the region scanning part and a specific pattern on the specific face part. A face attribute determining part determines a face attribute by comprehensively determining the similarities sequentially calculated by the pattern similarity calculating part. Therefore, a face attribute can be determined with high precision.

### CROSS-REFERENCE TO RELATED APPLICATIONS

The disclosure of Japanese Patent Application No. 2010-213825 filed on Sep. 24, 2010 including the specification, drawings and abstract is incorporated herein by reference in its entirety.

### BACKGROUND

The present invention relates to a technique for detecting a feature of a face of a person and, more particularly, to a face attribute estimating apparatus and method for estimating attributes of a face such as the opening/closing state of eyes, the degree of smiling, and the like.

In recent years, devices each having a camera sensor such as a digital still camera, a digital video camera, and a cellular phone are widely spread. Such devices can provide various functions to the user by performing an image process and an image recognizing process on an image obtained by the camera sensor.

For example, by detecting the face of a person from an image obtained by a camera sensor and extracting feature amounts of parts (regions) of the face, the open/close state of the eyes is determined, and the degree of smiling can be measured. Related techniques include the inventions disclosed in patent documents 1 and 2 which will be described below and a technique disclosed in non-patent document 1.

The patent document 1 discloses a facial expression detecting method of detecting the face of a person in an image, detecting the position of a face feature in the face, and determining a state, for example, an open/close state in the case of an eye or mouth.

The patent document 2 is directed to provide an apparatus, method, and program for determining the degree of opening of an eye and an imaging apparatus capable of detecting the degree of opening of an eye with high precision regardless of individual differences in the sizes of eyes. The apparatus for determining the degree of opening of an eye receives an image, detects the face of a person in the input image, calculates a feature amount related to the open/close state of an eye in the detected face, calculates the difference between the calculated feature amount and a predetermined feature amount as a feature change amount, and calculates the degree of opening of the eye in the detected face on the basis of a weighted feature amount and the feature change amount.

Non-patent document 1 proposes a method of detecting the face of a person and realizes both high discrimination performance and high processing performance.

### RELATED ART DOCUMENTS

### Patent Documents

[Patent Document 1] U.S. Patent Application Publication No. 2008/0025576
[Patent Document 2] Japanese Unexamined Patent Publication No. 2009-211180

### Non-Patent Document

[Non-Patent Document 1]
P. Viola and M. Jones, “Robust real time object detection”, in IEEE ICCV Workshop on Statistical and Computational Theories of Vision, July 2001

### SUMMARY

However, in the facial expression detecting method disclosed in the patent document 1, the position of a face feature such as an eye or mouth is detected and, then, the attribute of the face feature is determined, so that a correct result cannot be obtained unless the positioning of the face feature is correct. For example, in the case of detecting an eye, an eyebrow, an eye tail, the inner corner of an eye, or a shade is often erroneously detected as an eye. As a result, there is a problem such that it is difficult to obtain the degree of opening of an eye with high precision.

In the apparatus for determining the degree of opening of an eye disclosed in the patent document 2, the degree of opening of an eye has to be determined by using a plurality of images. Consequently, a memory of large capacity is required and a process amount becomes also large. There is also a problem such that control of the apparatus as a built-in system is difficult.

The present invention has been achieved to solve the problem and its object is to provide a face attribute estimating apparatus and method capable of determining a face attribute with high precision.

According to an embodiment of the invention, a face attribute estimating apparatus for detecting the face of a person in a still image and estimating an attribute of the face is provided. A face detecting part detects a face region of the person in the still image. A scan region extracting part extracts, as a scan region, a region in which a specific face part can exist from the face region detected by the face detecting part. A region scanning part sets a small region in the scan region extracted by the scan region extracting part and, while scanning the scan region with the small region, sequentially outputs a pixel value in the small region. A pattern similarity calculating part sequentially calculates similarity between the pixel value output from the region scanning part and a specific pattern on the specific face part. A face attribute determining part determines a face attribute by comprehensively determining the similarities sequentially calculated by the pattern similarity calculating part.

According to an embodiment of the present invention, the face attribute determining part determines a face attribute by comprehensively determining similarities sequentially calculated by the pattern similarity calculating part, so that the face attribute can be determined with high precision.

### BRIEF DESCRIPTION OF THE DRAWINGS

FIG. 1 is a block diagram showing an example of the configuration of a digital camera as an example of a system including a face attribute estimating apparatus in a first embodiment of the present invention.

FIG. 2 is a block diagram showing a functional configuration of the digital camera illustrated in FIG. 1.

FIG. 3 is a flowchart for explaining a procedure of the digital camera in the first embodiment of the invention.

FIG. 4 is a flowchart for explaining a detailed procedure of the digital camera in the first embodiment of the invention.

FIGS. 5A to 5C are diagrams showing examples of a face region detected by a face detecting part 12.

FIG. 6 is a diagram showing an example of a scan region extracted from the face region.

FIG. 7 is a diagram for explaining a scanning method by a region scanning part 14.

FIG. 8 is a diagram for explaining calculation of a feature amount in the case where a pattern similarity calculating part 15 uses the AdaBoost method.

FIG. 9 is a diagram for explaining a problem in a related-art technique.

FIG. 10 is a diagram for explaining weight Wₓ added to similarity.

### DETAILED DESCRIPTION

### First Embodiment

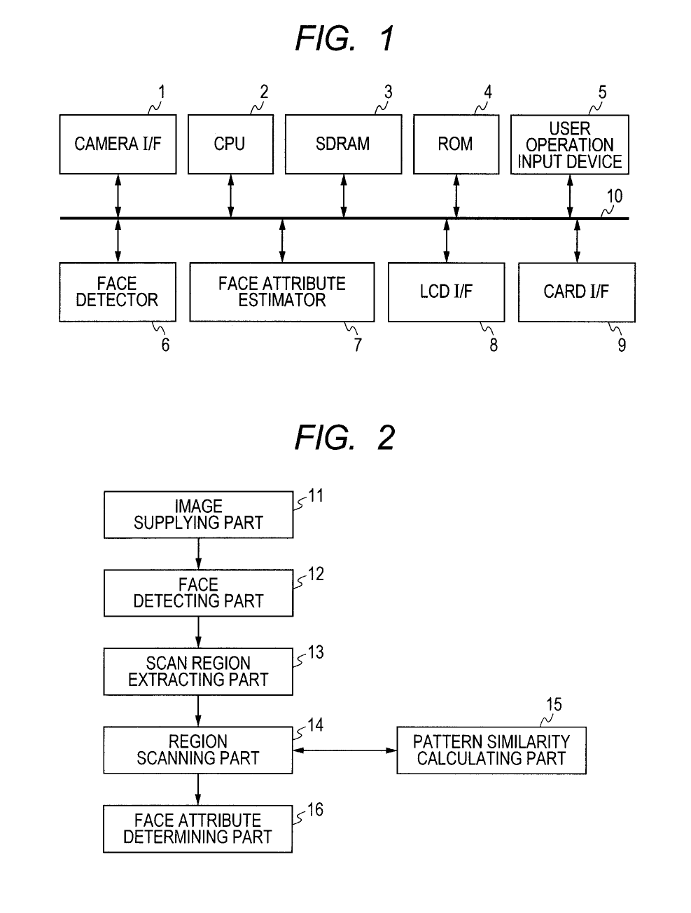

FIG. 1 is a block diagram showing an example of the configuration of a digital camera as an example of a system including a face attribute estimating apparatus in a first embodiment of the present invention. The digital camera includes a camera I/F (interface) 1, a CPU (Central Processing Unit) 2, an SDRAM (Synchronous Dynamic Random Access Memory) 3, a ROM (Read Only Memory) 4, a user operation input device 5, a face detector 6, a face attribute estimator 7, an LCD I/F 8, and a card I/F 9 which are coupled to each other via a bus 10.

The face attributes refer to attributes accompanying facial expressions such as the degree of opening of an eye and the degree of smiling and are estimated by extracting the states of the parts of the face. In the embodiment, the case of detecting a closing state of an eye by extracting the degree of opening of the eye will be mainly described. However, the invention is not limited to the case.

The camera I/F 1 is coupled to a camera sensor, receives an image captured by the camera sensor, and writes the image to the SDRAM 3 or a not-shown SD memory card or the like coupled via the card I/F 9.

The CPU 2 controls the entire system by executing programs stored in the SDRAM 3 and the ROM 4. Although FIG. 1 shows a configuration of the case where the face detector 6 and the face attribute estimator 7 are realized by hardware, the CPU 2 may realize the functions of the face detector 6 and the face attribute estimator 7 by executing a face detection program and a face attribute estimation program stored in the SDRAM 3 and the ROM 4.

As will be described later, the ROM 4 stores information regarding the range of possible positions of patterns of an eye to be used for extracting a scan region from position information of a face output from the face detector 6, information regarding a desired pattern used at the time of calculating similarity of patterns, and information such as a threshold used at the time of determining a face attribute.

The user operation input device 5 is configured by a shutter button or the like and, when an instruction from the user is received, notifies the instruction from the user to the CPU 2 by interruption or the like.

The face detector 6 detects the face of a person from a captured image which is stored in the SDRAM 3, a not-shown SD memory card, or the like and outputs the positional information and size of the face. Various methods of detecting the face of a person have been proposed. In the embodiment, for example, a method proposed by Viola et al. disclosed in the non-patent document 1 is used. However, the invention is not limited to the method. The positional information and size of a face may be also obtained by using a face detector on the outside of the system without providing the face detector 6 in the system.

The face attribute estimator 7 extracts the scan region from the face region detected by the face detector 6, calculates the similarity of images in small regions by scanning the inside of the scan region, and estimates an attribute of the face. The details of the face attribute estimator 7 will be described later.

The LCD I/F 8 is coupled to a not-shown LCD panel and performs control of display of the LCD and the like. The card I/F 9 is coupled to an external recording medium such as an SD memory card and reads/writes data from/to the recording medium.

The system shown in FIG. 1 performs face detection on an image captured by the camera and, after that, performs eye-closing determination. When a subject closes his/her eyes, the user is advised of the state by LCD display.

For example, when it is determined that the user depresses a shutter button with the user operation input device 5, the camera I/F 1 obtains an image captured by the camera sensor and stores it in the SDRAM 3 or the like. The face detector 6 detects the face of a subject from an image stored in the SDRAM 3 or the like, and outputs the position information and size of the face to the face attribute estimator 7.

The face attribute estimator 7 extracts a scan region from the face region detected by the face detector 6 and scans the scan region to determine whether the subject closes his/her eyes or not. When it is determined that the subject closes his/her eyes, the CPU 2 displays an image stored in the SDRAM to the LCD via the LCD I/F 8 and displays a message that the subject closes his/her eyes.

For example, a message such as “Closing of eyes of the subject is detected. Do you want to store the image?” is displayed on an OSD (On-Screen Display) or the like. In the case where the user selects to store the image with the user operation input device 5, the image is recorded in an external recording medium or the like via the card I/F 9.

Alternatively, the camera I/F 1 may obtain a plurality of images within predetermined time from the camera sensor, perform eye-closing detection on each of the images, automatically select only images in which the subject does not close his/her eyes, and record the selected images to an external recording medium or the like via the card I/F 9.

FIG. 2 is a block diagram showing a functional configuration of the digital camera illustrated in FIG. 1. The digital camera includes an image supplying part 11, a face detecting part 12, a scan region extracting part 13, a region scanning part 14, a pattern similarity calculating part 15, and a face attribute determining part 16.

The image supplying part 11 inputs one image by capturing an image by the camera sensor via the camera I/F 1 or obtaining an image stored in a storage medium such as an SD memory card via the card I/F 9. On the input image, blur correction, sharpening process, tone correction, and the like may be performed.

The face detecting part 12 corresponding to the face detector 6 shown in FIG. 1, detects the face of a person in an image obtained by the image supplying part 11, and outputs the position information and size (face region) to the scan region extracting part 13.

The scan region extracting part 13 extracts a scan region to be processed from the face region detected by the face detecting part 12. For example, in the case of determining the opening/closing state of an eye, the scan region is extracted from the range of possible positions of patterns of an eye to be scanned. The details of the scan region extracting part 13 will be described later.

The region scanning part 14 sets a small region in the scan region extracted by the scan region extracting part 13 and outputs a pixel value in the small region to the pattern similarity calculating part 15 while performing a scanning process for determining a face attribute. When similarity is received from the pattern similarity calculating part 15, the region scanning part 14 outputs the similarity to the face attribute determining part 16. The details of the region scanning part 14 will be described later.

When the pixel value of a small region is supplied from the region scanning part 14, the pattern similarity calculating part 15 calculates similarity to a desired pattern and outputs the calculated similarity to the region scanning part 14. The details of the pattern similarity calculating part 15 will be described later.

The face attribute determining part 16 determines a face attribute from each of the similarities obtained by performing the scanning process by the region scanning part 14. The details of the face attribute determining part 16 will be described later.

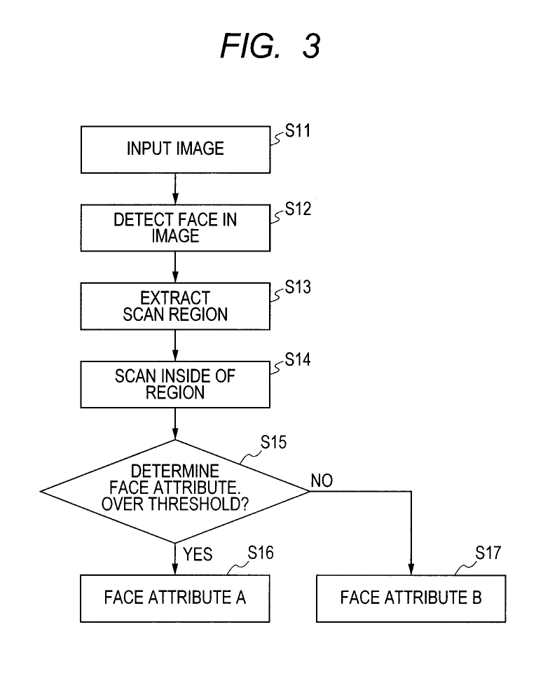

FIG. 3 is a flowchart for explaining a procedure of the digital camera in the first embodiment of the invention. First, the image supplying part 11 outputs one image to the face detecting part 12 (S11).

When the image is received from the image supplying part 11, the face detecting part 12 detects the face in the image and outputs the position information and size (face region) of the face to the scan region extracting part 13 (S12). The scan region extracting part 13 extracts a scan region as a range of possible positions of a pattern of an eye from the face region detected by the face detecting part 12 (S13).

Next, the region scanning part 14 sets a small region in the scan region extracted by the scan region extracting part 13 and sequentially outputs the pixel values of the small region by scanning the small region in the scan region (S14). The pattern similarity calculating part 15 calculates the similarity between the pixel value in the small region received from the region scanning part 14 and a desired pattern. The region scanning part 14 sequentially receives the similarity corresponding to the pixel value obtained by scanning the scan region by small regions from the pattern similarity calculating part 15, and sequentially outputs the similarity to the face attribute determining part 16.

The face attribute determining part 16 calculates the sum of the similarities received from the region scanning part 14 and determines whether the sum of the similarities exceeds a threshold or not (S15). In the case where the sum of the similarities exceeds the threshold (Yes in S15), a face attribute A is determined. For example, the face attribute A corresponds to a state where eyes are open. In the case where the sum of the similarities is equal to or less than the threshold (No in S15), a face attribute B is determined. For example, the face attribute B corresponds to a state where eyes are closed.

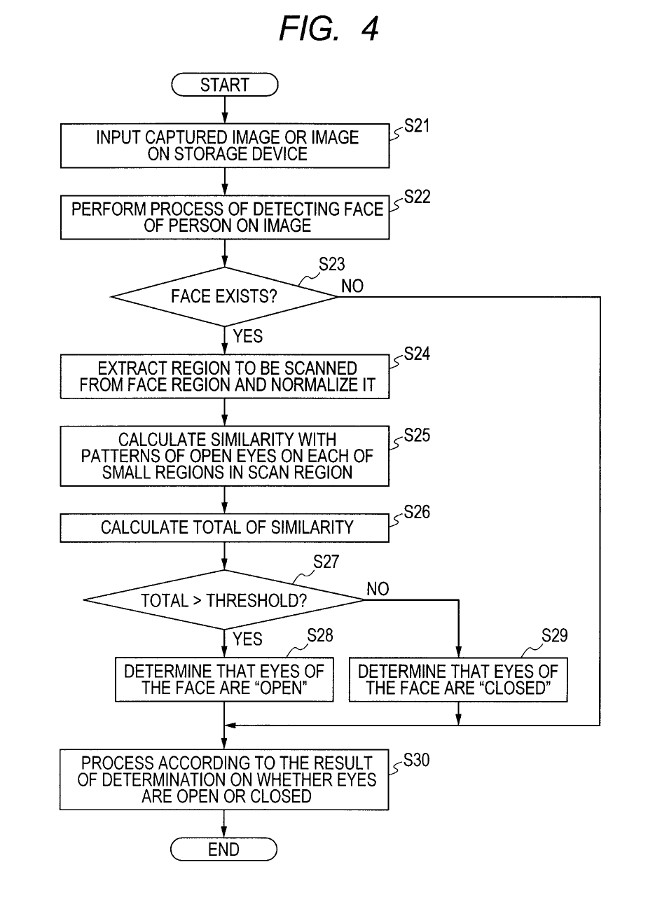

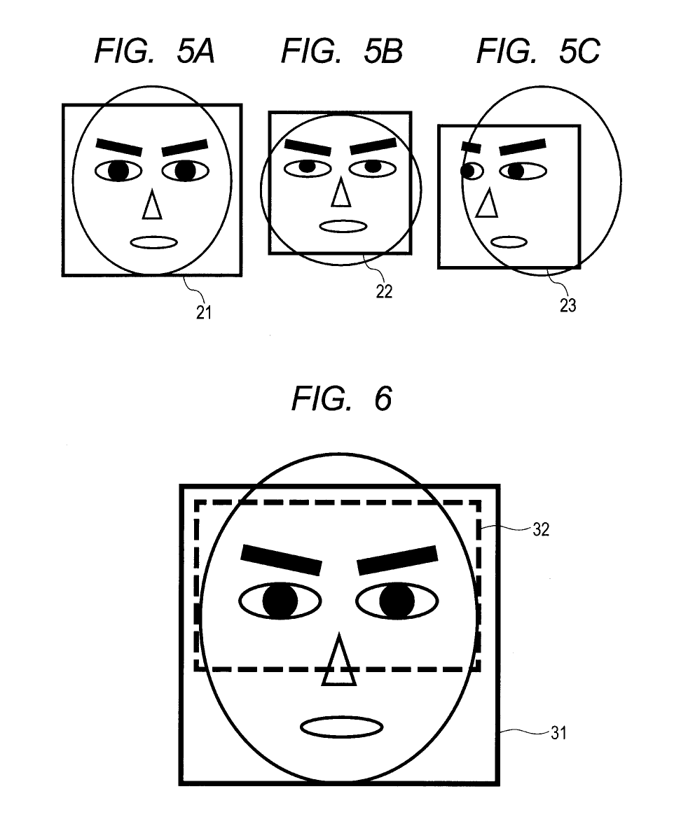

FIG. 4 is a flowchart for explaining a detailed procedure of the digital camera in the first embodiment of the invention. The procedure will be described with reference to FIGS. 5 to 10.

First, the image supplying part 11 supplies on image obtained from the camera sensor via the camera I/F 1 or an image on a recording device (recording medium) coupled to the card I/F 9 (S21). When the image is received from the image supplying part 11, the face detecting part 12 detects a face in the image and outputs position information and size (face region) of the face to the scan region extracting part 13 (S22).

FIGS. 5A to 5C are diagrams showing examples of the face region detected by the face detecting part 12. FIG. 5A shows a face region 21 of a person facing front. FIG. 5B shows a face region 22 of a person also facing front, but the position and size of the face region 22 are different from those of the face region 21 shown in FIG. 5A due to the difference in the contour of the face and parts of the face and according to the orientation of the face. FIG. 5C shows a face region 23 of a person facing sideways.

Next, whether a face exists in an image or not is determined from the position information and size output from the face detecting part 12. In the case where it is determined that no face exists (No in S23), the process goes to step S30.

In the case where it is determined that a face exists (Yes in S23), the scan region extracting part 13 extracts a region to be scanned in the face region (S24). The scan region is determined from the range of possible positions of a desired pattern. For example, in the case of determining the open/close state of eyes, the scan region is determined from the range of possible positions of patterns of eyes.

FIG. 6 is a diagram showing an example of a scan region extracted from the face region. In FIG. 6, a scan region 32 as a range of a possible position of the pattern of eyes is extracted from a face region 31. As a method of extracting such a scan region, for example, the range 32 of possible positions of the pattern of eyes in the face region 31 output from the face detecting part 12 is examined statically (statistically) in advance with respect to the angles and orientations of various faces and races, and the information is stored in the ROM 4. The scan region extracting part 13 extracts the scan region by reading the information from the ROM 4 or the like.

The scan region extracting part 13 normalizes an image in the extracted scan region 32 to a region image having predetermined resolution. A plurality of region images of resolutions may be generated.

Next, the region scanning part 14 sets a small region in the scan region extracted by the scan region extracting part 13 and sequentially outputs the pixel value in the small region by scanning the scan region by the small region to the pattern similarity calculating part 15.

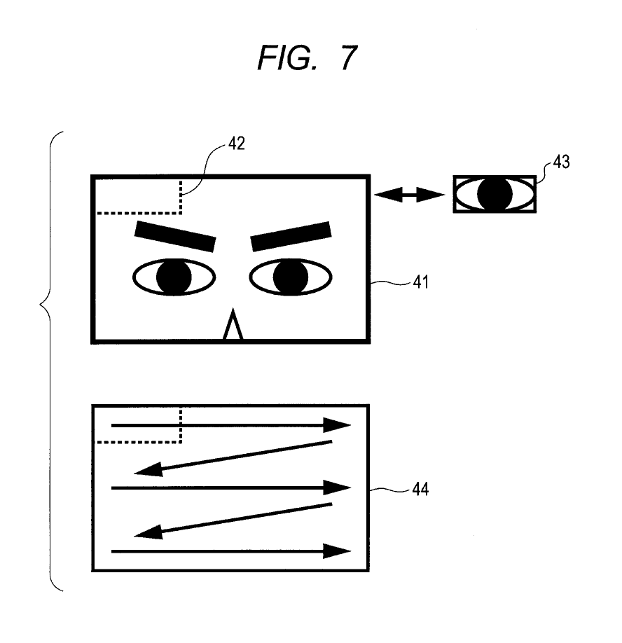

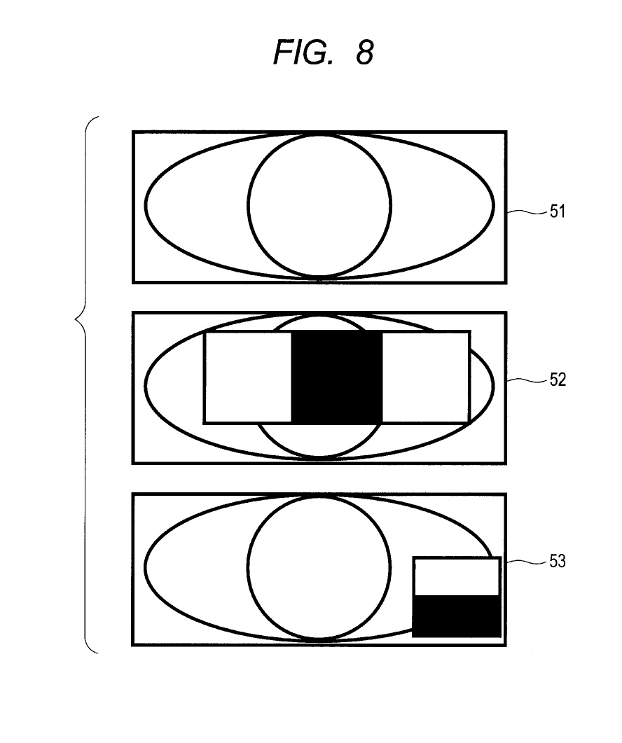

FIG. 7 is a diagram for explaining a scanning method by the region scanning part 14. As shown in FIG. 7, a small region 42 is set in a scan region 41. The region scanning part 14 sequentially outputs pixel values in the small region 42 to the pattern similarity calculating part 15 while shifting the small region 42 in the direction of the arrow in the scan region 41.

The scanning process by the region scanning part 14 may be performed while shifting the small region 42 in the direction of the arrow pixel by pixel or may be performed while shifting the small region 42 in the direction of the arrow pixels by pixels.

The pattern similarity calculating part 15 calculates the similarity indicating how similar an image in the small region output from the region scanning part 14 to a predetermined pattern is (S25). When the value of the similarity is large, it means that the image is similar to the predetermined pattern.

For example, the predetermined pattern is a pattern 43 of an open eye as shown in FIG. 7. Since the pattern of an eye varies according to the angle and orientation of a face, the race, age, the position of the pupil in the white part of the eye, and the like, the pattern similarity calculating part 15 has to output high similarity in all of the patterns.

The pattern similarity calculating part 15 calculates the similarity by using, for example, a method of using a normalization correlation value using the difference between a template image and a pixel value as a feature amount, the AdaBoost method for obtaining the similarity of patterns from information which is preliminarily learnt statically, or the like.

FIG. 8 is a diagram for explaining calculation of a feature amount in the case where the pattern similarity calculating part uses the AdaBoost method. In the AdaBoost method, rectangular regions 52 and 53 called Haar are set in a small region 51. A feature amount is obtained by subtracting total of pixel values of the white region in a rectangular feature from total of pixel values of the black region in the rectangular feature. The feature amount is called a Haar feature amount.

The pattern similarity calculating part 15 sets various Haars for the small region 51, calculates the Haar feature amounts, and adds a weight to each of the Haar feature amounts. When the value of a Haar feature “t” in a scan position “x” is expressed as hₜ (x) and a weight for the Haar feature amount is expressed as αₜ, similarity s(x) in the scan position x by AdaBoost is expressed by the following expression. The similarity s(x) is obtained by adding weights to Haar feature amounts corresponding to various Haars and totaling the weighted Haar feature amounts.

$$s ( x ) = {\sum }_{t = 1}^{T} {α}_{t} {h}_{t} ( x ) \qquad ( 1 )$$

The face attribute determining part 16 calculates a sum “f” of the similarities of the small regions calculated by the pattern similarity calculating part 15 (S26). The sum “f” of the similarities is obtained by totaling similarities s(x) corresponding to scan positions 1 to X.

$$f = {\sum }_{x = 1}^{X} s ( x ) \qquad ( 2 )$$

The face attribute determining part 16 determines whether the sum “f” is larger than a predetermined threshold or not (S27). When the sum “f” of similarities exceeds a predetermined threshold (Yes in S27), the face attribute determining part 16 determines the face attribute as A (S28). For example, the face attribute A corresponds to a state where an eye of a person is open.

When the sum “f” of the similarities is equal to or less than the predetermined threshold (No in S27), the face attribute determining part 16 determines the attribute as “B” (S29). For example, the face attribute B corresponds to a state where an eye of a person is closed.

In step S30, a process according to the result of the open/close state of the eye is performed, and the process is finished.

The face attribute determining part 16 may extract similarities each equal or larger than a threshold S_{threshold} from the similarities in the small regions and determine the face attribute by checking whether the sum exceeds a predetermined threshold or not as shown by the following expression.

$$f = {\sum }_{x = 1}^{X} \{ \begin{matrix}s ( x ) & [ s ( x ) \geq {S}_{threshold} ] \\ 0 & [ s ( x ) < {S}_{threshold} ]\end{matrix} \qquad ( 3 )$$

Not only the face attribute of the open/close state of an eye but also a face attribute of the degree of opening of an eye may be determined in accordance with the value of the sum “f” of similarities

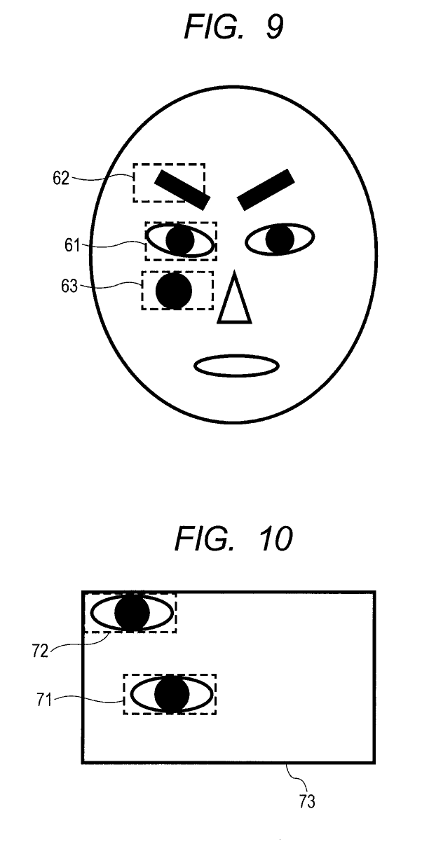

FIG. 9 is a diagram for explaining a problem in a relate-art technique. In the relate-art technique, in the case of determining a face attribute as an expression of a face, the positions, sizes, contours, and the like of face parts such as eyes, nose, mouth, and the like as targets are specified and the face attribute is determined from the shapes and feature amounts of the periphery. Therefore, as shown in FIG. 9, when the position of an eye is determined in a correct region 61, it is fine. However, a region 62 of an eyebrow or a region 63 of a shade is erroneously determined as the position of an eye, or a region of a frame of glasses, tail of an eye, inner corner of an eye, or the like is often erroneously determined as the region of an eye.

In the case of calculating the similarity of a pattern, it happens that the similarity of the region 62 of an eyebrow or the region 63 of a shade becomes higher than that of the correct region 61 of an eye. The reason is that, as described above, various patterns exist as the patterns of eyes depending on race, the orientation of a face, and the like and, when all of the patterns are handled, it becomes difficult to discriminate patterns of eyes from patterns of objects which are not eyes.

The face attribute estimating apparatus in the embodiment calculates the similarity to specific patterns in all of small regions in the scan region without specifying the position of a face part such as an eye, and determines a face attribute comprehensively and statistically. Consequently, regardless of the position of the specific pattern in the scan region, or even if another similar pattern exists, a face attribute can be determined with high precision.

Although the case where the digital camera is provided with the face attribute estimating apparatus has been described above, the apparatus can be also applied to a cellular phone, a surveillance camera, an in-vehicle device, and the like.

In the case where an image includes faces of a plurality of persons, the above-described process may be performed on each of the detected plurality of faces.

### Second Embodiment

The configuration and functional configuration of a system including a face attribute estimating apparatus in a second embodiment of the present invention are similar to those described in the first embodiment shown in FIGS. 1 to 4, and only the function of the face attribute determining part 16 differs. Therefore, the detailed description of the similar configuration and functions will not be repeated.

The face attribute determining part 16 calculates a sum “f” of the similarities by adding weights in accordance with positional information of small regions at the time of determining a face attribute from the similarity calculated by the pattern similarity calculating part 15. When a weight added to similarity s(x) in a small region is Wₓ, the sum “f” of the similarities is expressed by the following expression.

$$f = {\sum }_{x = 1}^{X} {W}_{x} s ( x ) \qquad ( 4 )$$

The weight Wₓ is obtained from the position of the small region. The closer to a position in which a pattern (small region) of a target whose similarity is to be checked in the scan region is obtained statistically and can exist most, the weight Wₓ is set to a larger value. With distance from the position, the weight Wₓ is set to a smaller value.

FIG. 10 is a diagram for explaining the weight Wₓ added to similarity. As shown in FIG. 10, a weight Wₓ₁ of a small region 71 closer to an average position of an eye in an extracted scan region 73 is set to a value larger than Wₓ₂ of a small region 72 in a far position.

As described above, in addition of the effect described in the first embodiment, the face attribute estimating apparatus in the second embodiment can exclude the similarity of a part which is apart in position such as an eyebrow at the time of calculating similarity of a pattern of an eye, and can perform estimation of a face attribute with high precision on various face images.

It is to be considered that the embodiments disclosed are illustrative and not restrictive in all of the aspects. The scope of the present invention is not defined by the scope of the claims rather than the foregoing description. All changes that fall within meets and bounds of the claims are intended to be embraced.

What is claimed is:

1. A face attribute estimating apparatus for detecting a face of a person in a still image and estimating an attribute of the face, comprising:
face detecting means which detects a face region of the person in the still image;
scan region extracting means which extracts, as a scan region, a region in which a specific face part can exist from the face region detected by the face detecting means;
region scanning means which sets a small region in the scan region extracted by the scan region extracting means and, while scanning the scan region with the small region, sequentially outputs a pixel value in the small region;
similarity calculating means which sequentially calculates similarity between the pixel value output from the region scanning means and a specific pattern on the specific face part; and
face attribute determining means which determines a face attribute by comprehensively determining the similarities sequentially calculated by the similarity calculating means.

2. The face attribute estimating apparatus according to claim 1, wherein the face attribute determining means determines the face attribute depending on whether sum of similarities of all of small regions calculated by the similarity calculating means exceeds a predetermined threshold or not.

3. The face attribute estimating apparatus according to claim 1, wherein the face attribute determining means adds a weight based on positional information of a small region to similarity of each of small regions calculated by the similarity calculating means and determines the face attribute according to whether sum of resultant values exceeds a predetermined threshold or not.

4. The face attribute estimating apparatus according to claim 1, wherein the scan region extracting means holds information on a region in which the face part exists statistically in the face region and extracts the scan region with reference to the information.

5. The face attribute estimating apparatus according to claim 1, wherein the similarity calculating means calculates a plurality of Haar feature amounts on a pixel value in the small region and uses, as the similarity, a sum of values obtained by adding weights to the plurality of Haar feature amounts.

6. A face attribute estimating method for making a computer detect a face of a person in a still image and estimate an attribute of the face, comprising the steps of:
detecting a face region of the person in the still image by the computer;
extracting, as a scan region, a region in which a specific face part can exist from the face region detected;
setting a small region in the extracted scan region and, while scanning the scan region with the small region, sequentially outputting a pixel value in the small region;
sequentially calculating similarity between the pixel value which is output and a specific pattern on the specific face part; and
determining a face attribute by comprehensively determining the similarities sequentially calculated.
